(19) United States
(12) Patent Application Publication
(10) Pub. No.: US 2021/0350664 A1
(43) Pub. Date: Nov. 11, 2021

(54) PRIZE VERIFICATION SYSTEM

(71) Applicant: Tommy L. Hutton II, Euless, TX (US)

(72) Inventor: Tommy L. Hutton II, Euless, TX (US)

(21) Appl. No.: 16/031,385

(22) Filed: Jul. 10, 2018

Related U.S. Application Data
(60) Provisional application No. 62/530,595, filed on Jul. 10, 2017.

(51) Int. Cl. G07F 17/32

(52) U.S. Cl. CPC G07F 17/3241; G07F 17/3223; G07F 17/329

(57) ABSTRACT

A prize verification system enables lottery participants to manage their selected numbers in that lottery. This includes quantifying the value of any prize money associated with the selected numbers as well as the results of the lottery even if no prize money is won. The system communicates between the lottery network and the participants via a portal and proxy server.

### BACKGROUND

### 1. Field of the Invention

The present invention relates generally to lottery systems, and more specifically, to a prize verification system for identifying the value of a lottery ticket.

### 2. Description of Related Art

Lottery systems are well known in the art and are effective means to collect money from a large group of people and grant winners from the pool to receive a prize. For example, FIG. 1 depicts a conventional number drawing game 101 having participants 103 each with a set of selected numbers 105 picked from a number range 111. A random set of winning numbers 107 is drawn or selected. The participants 103 with the exact or close match wins the prize 109.

One of the problems commonly associated with system 101 is limited efficiency. For example, frequently, number drawing games have large numbers of participants, sometimes in the millions. Participants who know they did not have an exact match discard their numbers without validating if any prize money was won. This results in large numbers of unclaimed small prizes.

Accordingly, although great strides have been made in the area of lottery systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a diagram of a common numbers drawing game;

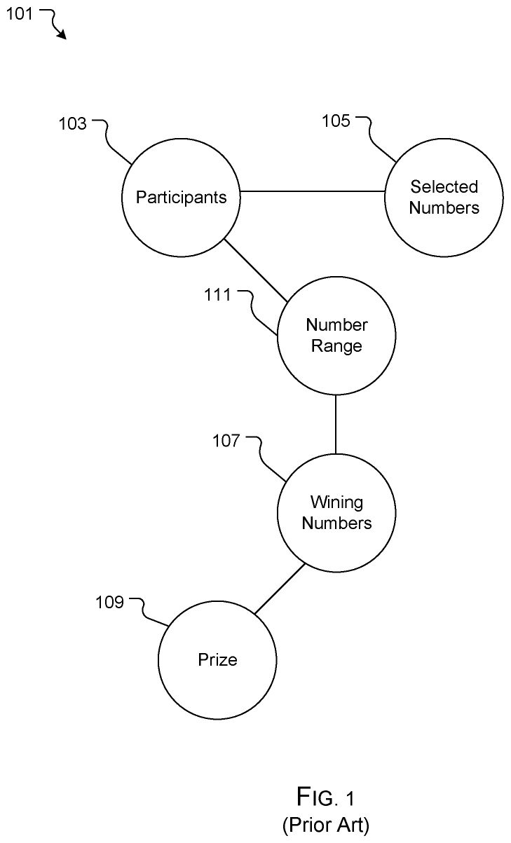

FIG. 2 is a diagram of a prize verification system in accordance with a preferred embodiment of the present application;

FIG. 3 is a flowchart of the preferred method of use of the system of FIG. 2; and

FIG. 4 is a diagram of an alternative embodiment of the portal of FIG. 2.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional number drawing games. Specifically, the system of the present invention enables the verification of winning numbers in a lottery as well as the prize quantity. In addition, the system facilitates the participation with lottery systems by of enabling the purchase of numbers. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

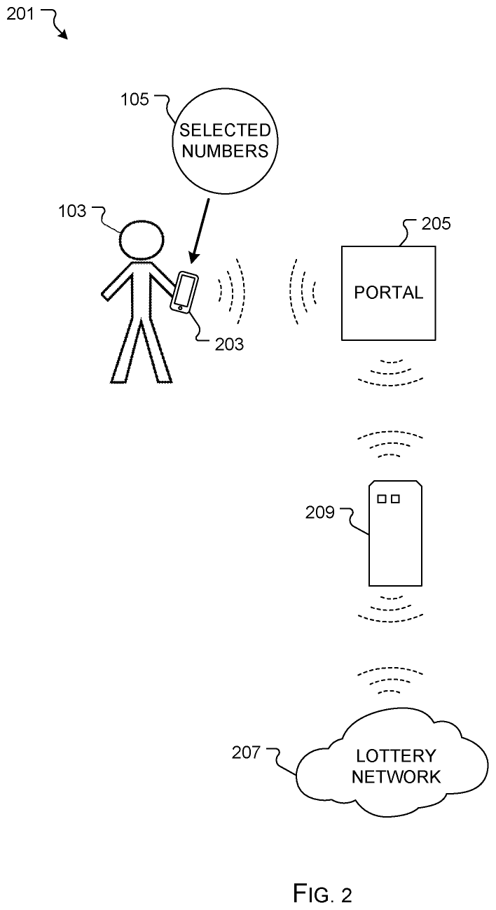

Referring now to the drawings wherein like reference characters identify corresponding or similar elements throughout the several views, FIG. 2 depicts a diagram of a prize verification system in accordance with a preferred embodiment of the present application. It will be appreciated that system 201 overcomes one or more of the above-listed problems commonly associated with conventional number drawing games.

In the contemplated embodiment, system 201 includes an electronic device 203 capable of capturing a set of selected numbers 105. The device 203 is digital communication with a portal 205 that is communication with a lottery network 207 via a proxy server 209.

In use, the proxy server 209 enables the portal 205 to communicate with the lottery network 207. The participant 103 inputs their selected numbers 105 to the portal 203. The portal 203 tracks the progress of the lottery via the lottery network 207. The portal marks selected numbers 105 that have prize value after the completion of a lottery.

It should be appreciated that one of the unique features believed characteristic of the present application is that proxy server 209 and portal 205 enable participants to engage with lottery systems from remote locations. It will also be appreciated that portal 205 facilitates the verification of the selected numbers 105 for a prize.

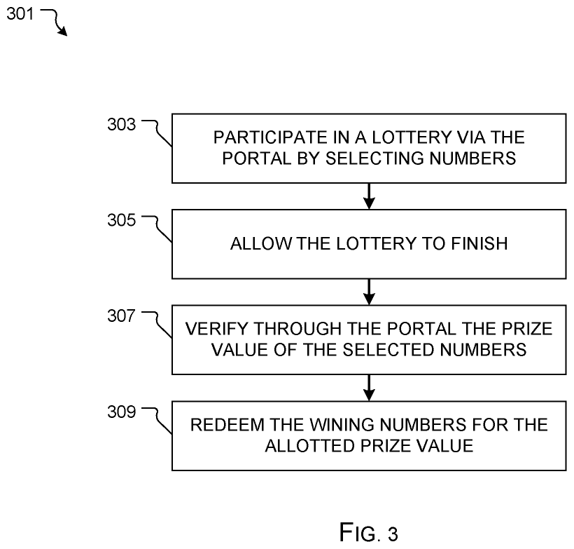

Referring now to FIG. 3 the preferred method of use of the system 201 is depicted. Method 301 including participating in a lottery via the portal by selecting numbers 303, allowing the lottery to finish 305, verifying through the portal the prize value of the selected numbers 307 and redeeming winning numbers for the allotted prize value 309.

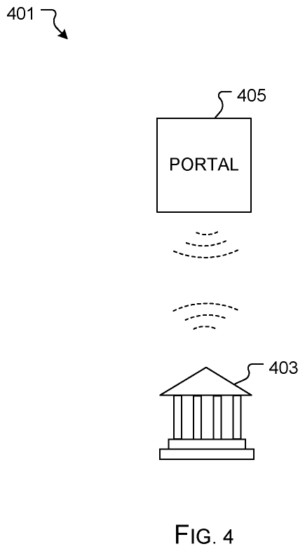

Referring now to FIG. 4 an alternative embodiment of the portal 205 is depicted. Embodiment 401 including a financial institution 403 in digital communication with a portal 405. It will be appreciated that embodiment 401 enables the prize winnings to be efficiently transferred from the lottery to the participant upon presenting a set ow wining selected numbers 105.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. A prize verification system comprising:
a portal in communication with at least one lottery network via a proxy server; and
a set of selected numbers input to the portal via an electronic device;
wherein the portal queries the lottery network to quantify the value of any potential prize money associated with the selected numbers.

2. The system of claim 1 wherein the numbers are selected and purchased through the portal.

3. The system of claim 1 wherein the portal is in communication with at least one financial institution and is able to transfer or receive funds from lottery winnings.

4. A method of participating in a lottery given the system of claim 1, comprising:
participating in a lottery via the portal by selecting numbers;
allowing the lottery to finish;
verifying through the portal the prize value of the selected numbers; and
redeeming winning number for the allotted prize value.
